(19) United States
(12) Patent Application Publication
(10) Pub. No.: US 2023/0034129 A1
(43) Pub. Date: Feb. 2, 2023

(54) SYSTEM AND METHOD FOR IMMERSIVE EFFECTS FOR PLUG AND PLAY VIRTUAL REALITY

(71) Applicant: Fantasy 360 Technologies Inc., Vancouver (CA)

(72) Inventors: Adrian Duke, West Kelowna (CA); Lance Fisher, Vernon (CA); Daniel Prado, North Vancouver (CA)

(21) Appl. No.: 17/871,772

(22) Filed: Jul. 22, 2022

Related U.S. Application Data
(60) Provisional application No. 63/228,007, filed on Jul. 30, 2021.

(30) Foreign Application Priority Data
Jan. 19, 2022 (CA) CA3146149

(51) Int. Cl. A63F 13/28; A63F 13/837

(52) U.S. Cl. CPC A63F 13/28; A63F 13/837; A63F 2300/8082

(57) ABSTRACT

A system for immersive effects in a portal implemented using a portable space for multiplayer virtual reality games. The portal comprises a control room and arenas in proximity to, and communicatively coupled to the control room. Each of the arenas accommodates one or more players, and comprises immersive effects subsystems communicatively coupled to a gaming control subsystem. The immersive effects subsystems receive immersive effects signals from the gaming control subsystem, and produces immersive effects for the players based on the immersive effects signals. The gaming control subsystem receives input signals from communicatively coupled input subsystems, which were generated by the input subsystems based on receiving game-related inputs. The gaming control subsystem generates the immersive effects signals based on at least one of: the gaming control subsystem executing programs related to the game, and the gaming control subsystem processing the input signals received from the input subsystems.

The present application claims priority as a non-provisional of U.S. application 63/228,007, filed on Jul. 30, 2021, presently pending. The present application also claims priority to Canadian Application CA3146149, filed on Jan. 19, 2022, presently pending. The contents of each application is hereby incorporated by reference.

### TECHNICAL FIELD

The present disclosure generally relates to virtual reality gaming systems. More particularly, the present disclosure relates to a system and method for immersive effects in a portable or mobile multiplayer virtual reality gaming system.

### SUMMARY

A further understanding of the functional and advantageous aspects of the invention can be realized by reference to the following detailed description.

An object of the present disclosure is to provide immersive effects for a portal using a portable or mobile space for multiplayer virtual reality games.

Thus by one broad aspect of the present invention, a system for immersive effects in a portal implemented using a portable space for multiplayer virtual reality games, wherein: the portal comprises at least one control room and a plurality of arenas, wherein the plurality of arenas are in proximity to the control room, the plurality of arenas are communicatively coupled to the control room, each of the plurality of arenas accommodates a corresponding one or more players, each of the plurality of arenas comprises one or more immersive effects subsystems communicatively coupled to at least one gaming control subsystem, the one or more immersive effects subsystems receiving one or more immersive effects signals from the at least one gaming control subsystem, and the one or more immersive effects subsystems produces one or more immersive effects for the corresponding one or more players based on the received one or more immersive effects signals, the at least one gaming control subsystem receiving one or more input signals from one or more communicatively coupled input subsystems, the one or more input signals generated by the one or more input subsystems based on receiving one or more inputs related to a game, the at least one gaming control subsystem generating the immersive effects signals based on at least one of: the at least one gaming control subsystem executing one or more programs and data related to the game, and the at least one gaming control subsystem processing the input signals.

By a further broad aspect of the present invention, A method for immersive effects in a portal implemented using a portable space for multiplayer virtual reality games, wherein: the portal comprises at least one control room communicatively coupled to a plurality of arenas, each of the plurality of arenas accommodates a corresponding one or more players, each of the plurality of arenas comprises: one or more immersive effects subsystems communicatively coupled to at least one gaming control subsystem, the method comprises: receiving, by the one or more immersive effects subsystems, one or more immersive effects signals from the at least one gaming control subsystem, wherein the one or more immersive effects signals are generated by the at least one gaming control subsystem based on at least one of the at least one gaming control subsystem executing one or more programs and data related to the game, and the at least one gaming control subsystem processing one or more input signals received from one or more input subsystems located within each of the plurality of arenas, and producing, by the one or more immersive effects subsystems, one or more immersive effects for the corresponding one or more players based on the received one or more immersive effects signals.

### BRIEF DESCRIPTION OF DRAWINGS

FIG. 1A illustrates an embodiment of the portal for a portable or mobile space for multiplayer virtual reality games.

FIG. 1B illustrates an example embodiment of an implementation of a portal using a shipping container.

FIG. 1C illustrates an example embodiment of a process for generating immersive effects in the portal.

FIG. 1D illustrates an example embodiment of a process for generating audiovisual effects in the portal.

FIG. 2A illustrates an example embodiment of an arena within a portal comprising input sub systems.

FIG. 2B illustrates an example embodiment of a gunner console.

FIG. 3A illustrates an example embodiment of an arena within a portal comprising immersive effects and other subsystems.

FIG. 3B illustrates an example embodiment of an air-conditioning unit for an arena within a portal.

FIG. 4A illustrates an example embodiment of a rumble floor located in an arena.

FIG. 4B illustrates an example embodiment of a rumble floor divided into sections.

FIG. 4C illustrates an example embodiment of transducers producing immersive effects in the form of vibrations as a player walks on a rumble floor.

FIG. 4D illustrates another example embodiment of transducers producing immersive effects in the form of vibrations as a player walks on a rumble floor.

FIG. 4E is a detailed illustration of an embodiment of a transducer.

FIGS. 4F and 4G illustrate a player experiencing immersive effects in the form of heat from a heating and cooling effects subsystem.

FIGS. 4H and 4I illustrate a player experiencing immersive effects in the form of cold air from a heating and cooling effects subsystem.

FIGS. 4J and 4K illustrate a player experiencing immersive effects in the form of air flows from a wind effects subsystem.

FIGS. 4L and 4M illustrate a player experiencing immersive effects in the form of air blasts from an air blast subsystem.

FIGS. 4N and 4O illustrate a player experiencing immersive effects in the form of scents from an olfactory effects subsystem.

FIGS. 4P and 4Q illustrate a player experiencing immersive effects from a virtual reality folding seat.

FIGS. 4R and 4S illustrate a player providing inputs to and experiencing immersive effects from an object interaction subsystem.

FIG. 4T illustrates a player receiving immersive effects from a haptic interaction subsystem.

### BACKGROUND

In recent years there has been a growing need for virtual reality gaming portals located within an indoor or outdoor portable or mobile space. Organizations have been using these portals in, for example, exhibitions, conferences, shopping mall car parks, and other indoor and outdoor spaces to enable patrons to enjoy immersive experiences, without the costs and space requirements associated with a portal in a fixed-location arena.

Implementing a virtual reality gaming portal or system in an indoor or outdoor portable or mobile space to deliver immersive experiences via production of immersive effects, poses challenges not seen when implementing a virtual reality gaming portal or system in a fixed-location arena.

Fixed-location arenas are typically more spacious and therefore constrain the arena operator less when trying to install immersive effects or other infrastructure needed to support such a portal. For example, mobile and portable spaces offer less options for configuration for acoustic enjoyment when compared to fixed spaces, as acoustic considerations are not necessarily a major consideration in the design of these spaces. For example, implementing a virtual reality gaming portal or system in a shipping container is acoustically challenging, as acoustics are not taken into account in the design and building of shipping containers. Also, certain types of sensors work better in a fixed space compared to a mobile space. For example, in fixed spaces, sensors that rely on infra-red (IR) radiation and light for operation are less likely to have to deal with back-reflections, when compared to a mobile space. Also, conforming to air and fire safety regulations in a fixed space tends to be easier than in a confined mobile space. Finally, due to the number of people and the density of equipment in a confined mobile space, this imposes more requirements for temperature control.

Previously, there have been attempts to deliver virtual reality experiences with immersive effects in portable or mobile spaces. For example, the show titled “The Invisible” (further information provided at https://www.darkfield.org/the-invisible, retrieved 10 Jan. 2022), is a virtual reality show with immersive effects provided within a shipping container in 2020 at Universal Studios Hollywood, California in the United States of America. The Welsh National Opera created the Magic Butterfly virtual reality system with immersive audio to host the Madame Butterfly and The Magic Flute operas within a shipping container, which toured worldwide in the summer of 2017 and 2018. (retrieved 10 Jan. 2022, from https://wno.org.uk/archive/2017-2018/magic-butterfly)

While these are examples of immersive effects in different virtual reality applications, these are not examples of immersive effects for gaming or other interactive applications. In gaming and other interactive applications, players receive stimuli produced due to the execution of certain commands and transmission of signals. These stimuli comprise one or more immersive effects. The players interact with the game in response to the stimuli received, and the gaming control systems execute commands to provide new stimuli and immersive effects based on the responses received from the players. In the prior art and prior use experiences detailed above, stimuli were provided, but responses were not received, and therefore no commands were executed based on received responses.

United States Patent Application Publication No. 2019/0247269 to Devanaboyina et al describes weight distribution devices and load concentration devices to simulate the feeling of motion in a user for immersive experiences in a virtual reality environment. Addition and removal of pressure combined with use of audio and video signals is used to deliver the experience of motion for a virtual reality environment. While United States Patent Application Publication No. 2019/0247269 describes use in a shipping container or a portable or mobile space to reduce discomfort to animals, it does not describe how the immersive effects can be deployed for use in a gaming portal implemented in a portable or mobile space such as shipping container.

### DETAILED DESCRIPTION

The present disclosure provides a system and method for immersive effects for a virtual reality gaming system. The systems and methods described herein allow for the implementation of immersive effects in a plug and play virtual reality gaming portal, which uses a portable or mobile space taking up a small footprint, and can be readily installed in an indoor or outdoor space. A worker skilled in the relevant art would appreciate that the system and method for immersive effects for a plug and play virtual reality gaming portal described herein can be applied to other industries wherein a virtual reality portal may be used. Such examples of industries include, but are not limited to, training for professions such as aviation, large machinery operation, or disaster relief and virtual experiences such as travel.

In some embodiments, the portable space comprises a shipping container. In some embodiments, as will be described below, multiple shipping containers may be connected and/or stacked to provide further capacity for additional players and games.

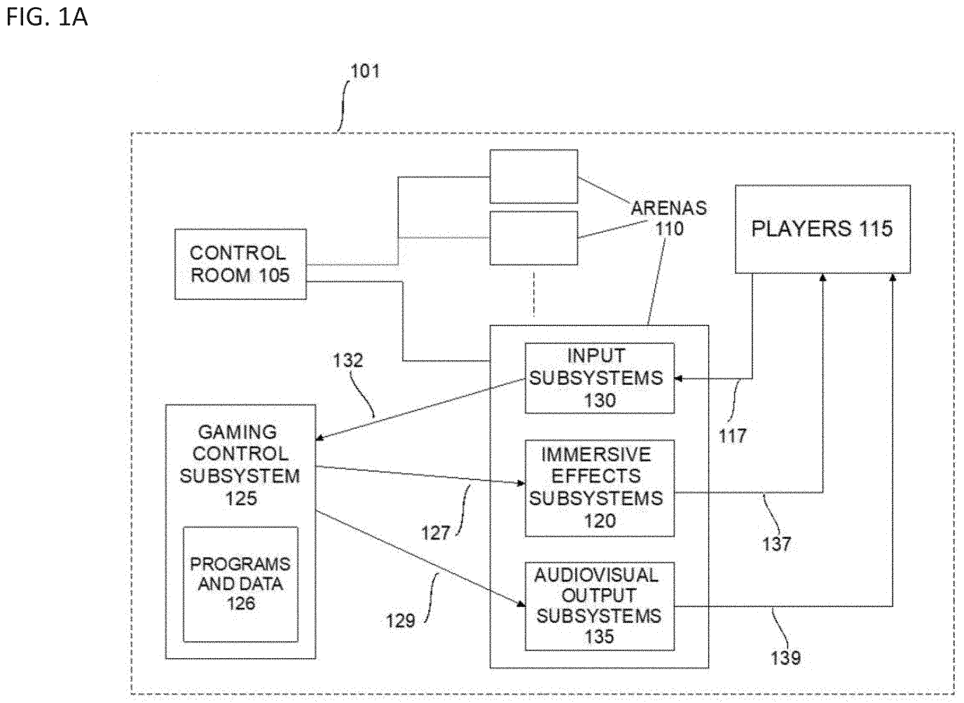

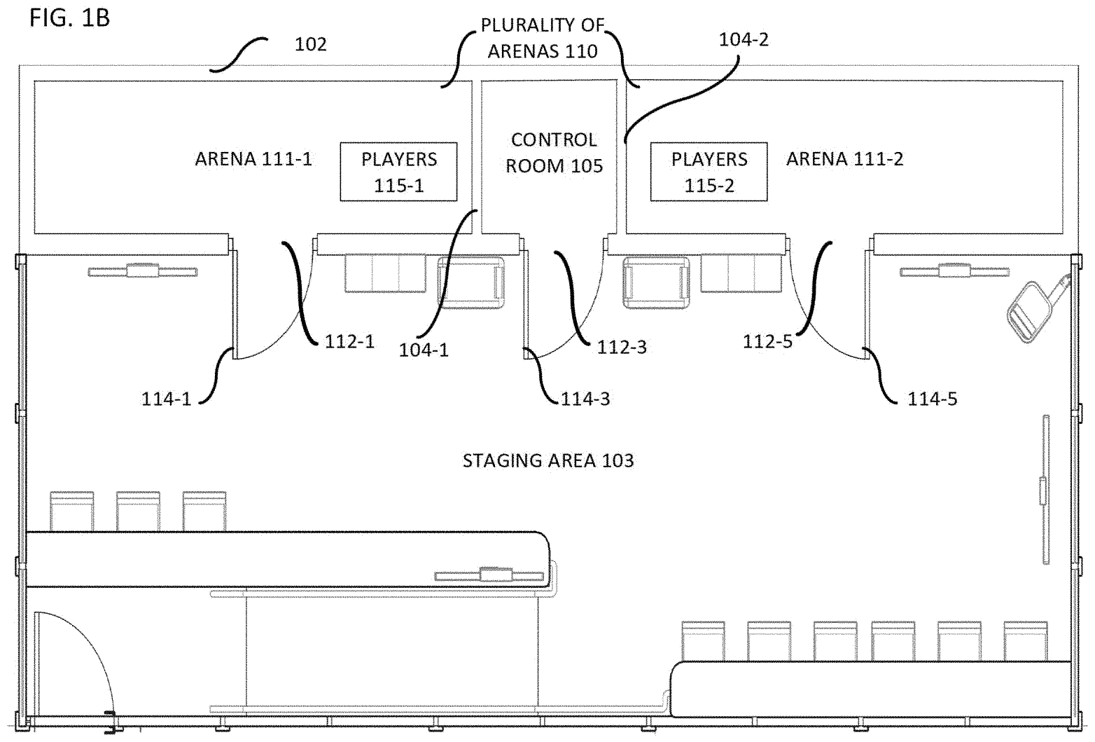

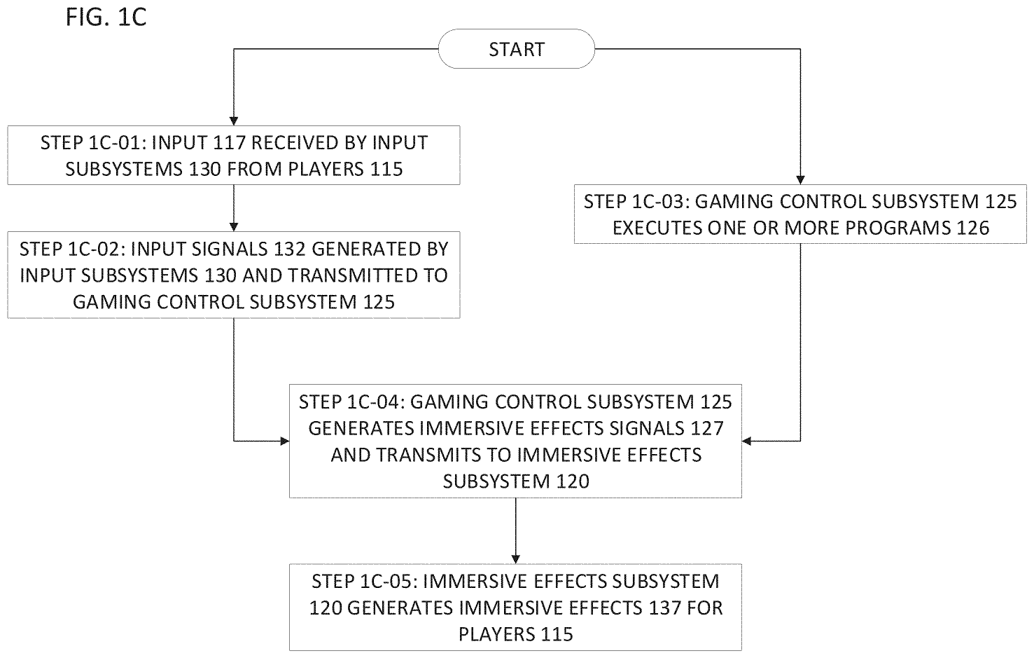

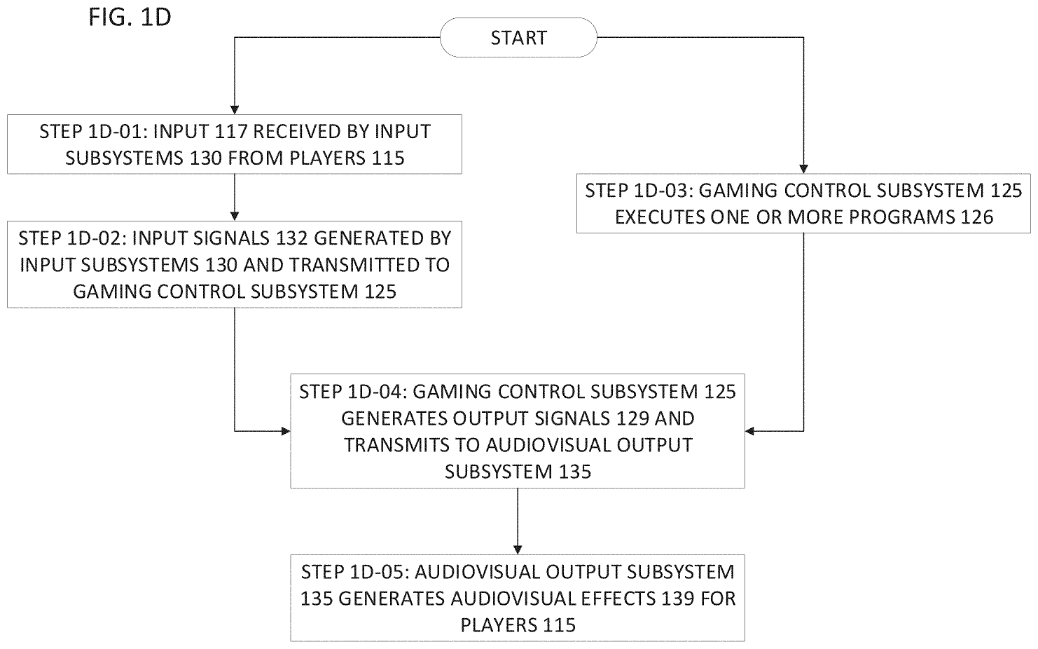

Further details of the plug and play virtual reality gaming portal and the immersive effects are provided below with reference to FIGS. 1A to 4T. In FIG. 1A, an embodiment of the portal for a portable or mobile space for multiplayer virtual reality games 101 is illustrated in detail. The embodiment shown in FIG. 1A comprises at least one control room 105 and a plurality of arenas 110. In some embodiments, the plurality of arenas 110 are communicatively coupled to the control room 105. In some embodiments, the plurality of arenas 110 are physically coupled to the control room 105.

An example embodiment of an implementation using a shipping container 102 is shown in FIG. 1B. The embodiment in FIG. 1B shows an example where plurality of arenas 110 comprise arenas 111-1 and 111-2. These arenas are physically and communicatively coupled to control room 105. Arena 111-1 is physically coupled to control room 105 via adjoining wall 104-1, and arena 111-2 is physically coupled to control room 105 via adjoining wall 104-2. In some embodiments, a plurality of arenas 110 and control room 105 are implemented within shipping container 102. Methods and techniques to communicatively couple arenas 111-1 and 111-2 to control room 105 will be explained further below.

Referring to FIG. 1A, the plurality of arenas 110 accommodates one or more players 115. So, for example, with reference to FIG. 1B, arena 111-1 accommodates one or more players 115-1, and arena 111-2 accommodates one or more players 115-2.

Referring to FIG. 1B, in some embodiments, the portal comprises a staging area 103, which is proximate to the arenas 110 and control room 105. For example, in FIG. 1B, control room 105 and the plurality of arenas 110 comprising arenas 111-1 and 111-2 are proximate to a staging area 103. One or more players 115-1 and 115-2 can enter the arenas using entrances with doors. For example, one or more players 115-1 can enter arena 111-1 using entrance 112-1 with door 114-1. Similarly, one or more players 115-2 can enter arena 111-2 using entrance 112-5 with door 114-5. Personnel can enter the control room 105 from staging area 103 via entrance 112-3 with door 114-3.

The following along with FIGS. 1A, 2A, 2B, 3A, 3B and 4A-4T are used to provide explanations of the operation of input subsystems 130, immersive effects subsystems 120 and audiovisual output subsystems 135 shown in FIG. 1A. In the descriptions below, in some embodiments, communications between the various components of FIG. 1A and within, for example, the gaming control subsystem 125 are performed using User Datagram Protocol (UDP).

Referring to FIG. 1A, input subsystems 130 receive inputs 117 related to a game from one or more players 115, and generate input signals 132 for transmission to gaming control subsystem 125. In some embodiments, the input signals 132 comprise a UDP command. The one or more input effects subsystems 130 are communicatively coupled to at least one gaming control subsystem 125. The at least one gaming control subsystem 125 is implemented using software, hardware or a combination of both. In some embodiments, the at least one gaming control subsystem 125 comprises components such as servers, programmable logic controllers (PLC), central processing units (CPUs) and other processing elements and hardware for the control and operation of various virtual reality games. In some embodiments, the at least one gaming control subsystem 125 comprises storage and databases to store programs and data necessary for the control and operation of various virtual reality games. In some embodiments, the components of gaming control subsystem 125 comprise software such as one or more programs and data 126. One or more programs and data 126 are related to one or more games and are stored within gaming control subsystem 125. One or more programs and data 126 are used for control and operation of various virtual reality games. An example of software used as part of gaming control subsystem 125 is software which is part of the Unity development engine. An example of such software is a Unity game. In further embodiments, the gaming control subsystem 125 also comprises visual display units such as monitors and television sets to enable personnel to view the current state of the portal 101. Gaming control subsystem 125 processes the received one or more input signals 132 using, for example, the one or more programs and data 126 stored within gaming control subsystem 125. The results of the processing are used to generate other signals, as will be explained below. Additionally, the gaming control subsystem 125 executes the one or more programs and data 126 to generate and transmit other signals for the control and operation of various virtual reality games and other subsystems, as will also be explained below. In some embodiments, at least some portion of gaming control subsystem 125 is located within control room 105. In virtual reality game environments, it is important that the timings of various immersive and audiovisual effects be matched with each other so as to optimize the virtual reality gaming experience for the one or more players 115. Then, gaming control subsystem 125 is cognizant of the portable or mobile space, and ensures that the timings of the various effects are coordinated with each other. In some embodiments, the processing of the input signals and the generation of various signals by the gaming control subsystem 125 takes into account the nature of the portable or mobile space so as to optimize the experience.

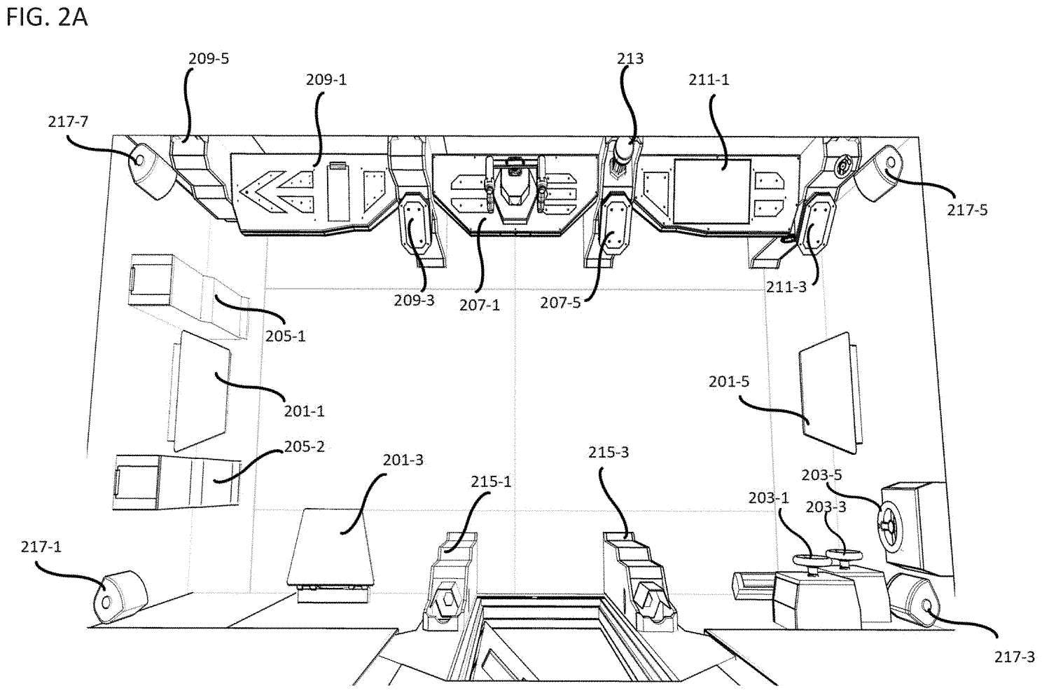

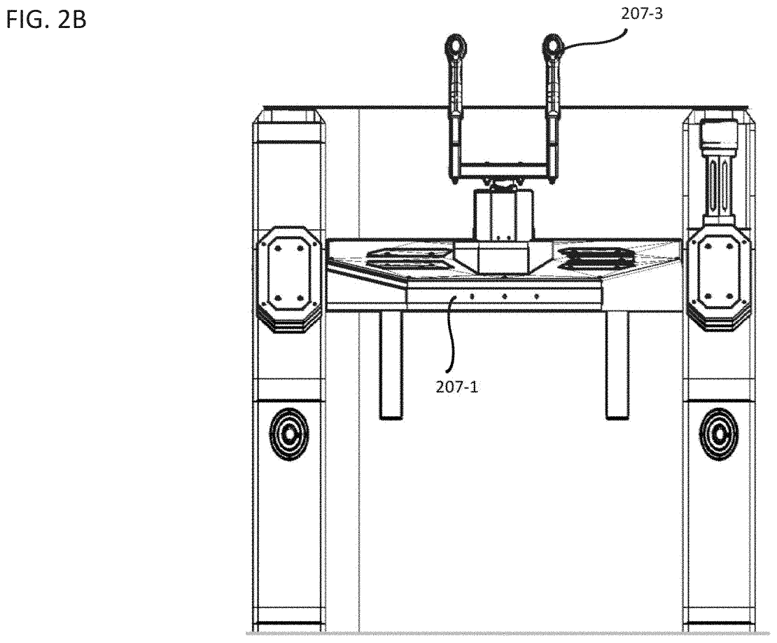

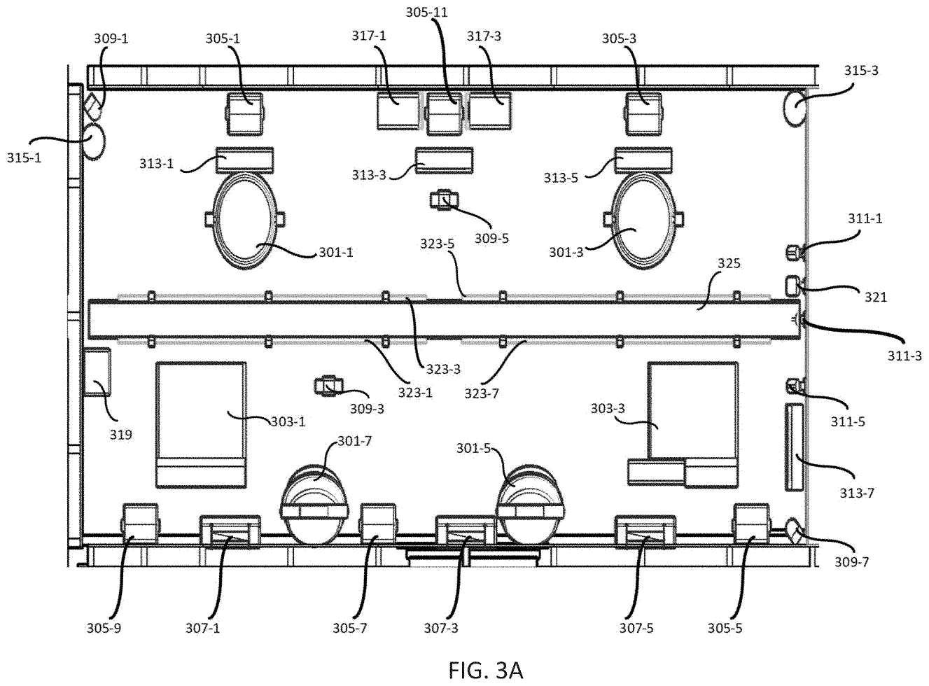

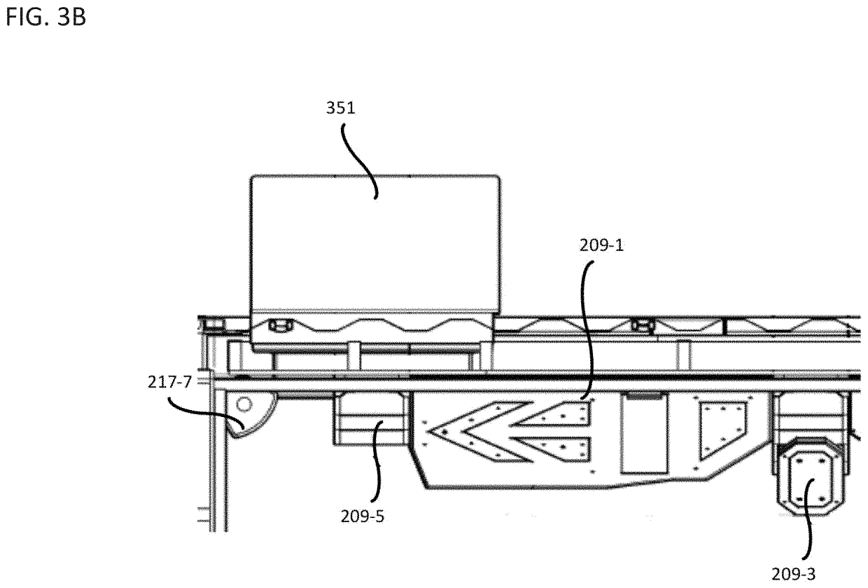

An example embodiment of input subsystems 130 implemented within, for example, arena 111-1 of FIG. 1B is described below with reference to FIGS. 2A, 2B, and 3A. In FIG. 2A:
wheels 203-1, 203-3, and 203-5;
lever assemblies, such as navigation lever assemblies 205-1 and 205-2;
consoles such as
   gunner console 207-1, which comprises gunner control 207-3 as shown in FIG. 2B,
   navigation console 209-1, and
   engineering console 211-1; and
ammunition canister assembly 213;
   are examples of input subsystems 130 to receive player inputs. These input subsystems 130 are distributed throughout the interior of an arena such as arena 111-1, and are appropriately located to enable interaction with, for example the one or more players 115-1 within arena 111-1.

These input subsystems produce input signals 132, which are then transmitted to gaming control subsystem 125. In some of these example embodiments, as explained previously, at least some portion of gaming control subsystem 125 is located within control room 105. Then, the input signals 132 are transmitted to control room 105 via the communicative coupling between arena 111-1 and control room 105.

The communicative coupling between arena 111-1 and control room 105 may be implemented in a variety of ways. For example, as will be further explained below, in some embodiments, the communicative coupling is achieved using one or more networks such as wireless networks, wired networks, Ethernet networks, local area networks, metropolitan area networks and optical networks. In some embodiments, the one or more networks comprise at least one of a private network, such as a virtual private network, or a public network such as the Internet. In some embodiments, the communicative coupling is achieved using one or more direct connections between the control room 105 and arena 111-1. Various wired or wireless communications protocols known to those of skill in the art may be used to implement the communicative coupling. These include, for example, near field communications (NFC), Wi-Fi, short-range wireless technologies such as BLUETOOTH, Radio Frequency Identification (RFID), 3G, Long Term Evolution (LTE), 5G, and Universal Serial Bus (USB).

For example, with reference to the specific implementation shown in FIG. 3A, base stations 309-1, 309-3, 309-5, and 309-7 are used to couple the various subsystems described above to the gaming control subsystem 125 implemented in control room 105. Furthermore, wired communications are also implemented using cables installed in arena 111-1 via wire tray 325.

As shown in FIG. 1A, each of the arenas 110 includes one or more immersive effects subsystems 120. Immersive effects subsystems 120 receive immersive effects signals 127 and generate immersive effects 137 for the one or more players 115.

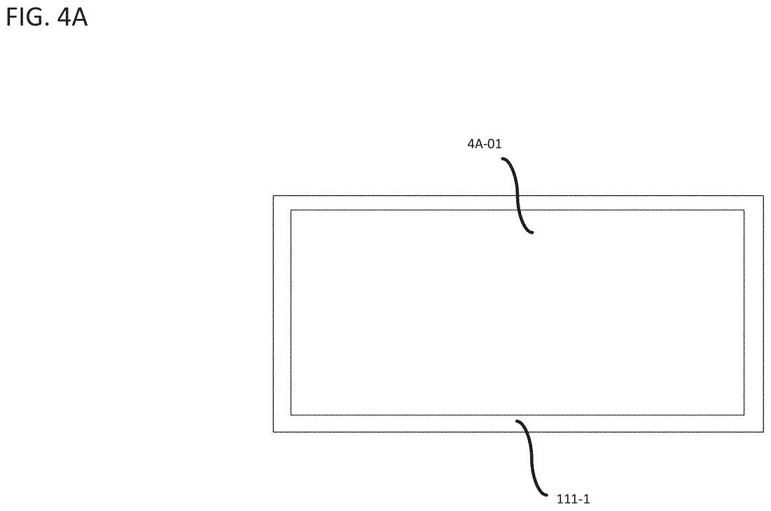

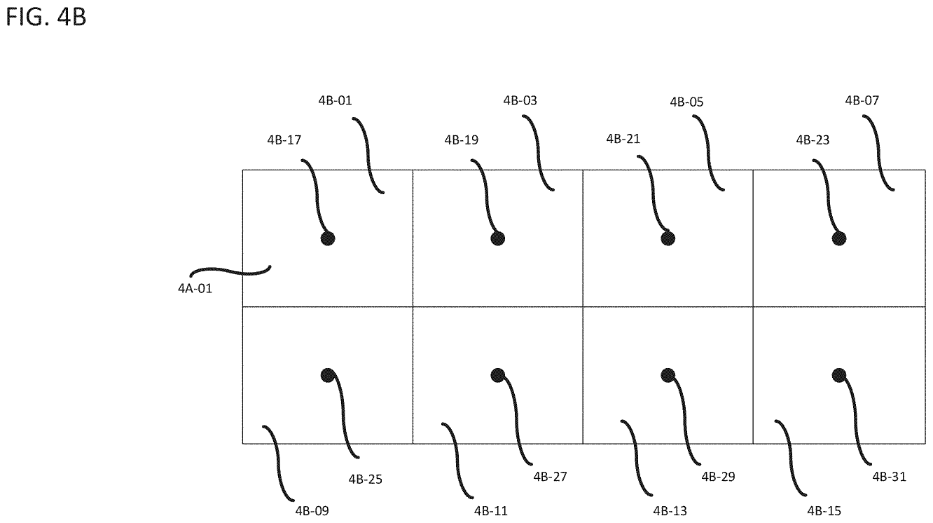

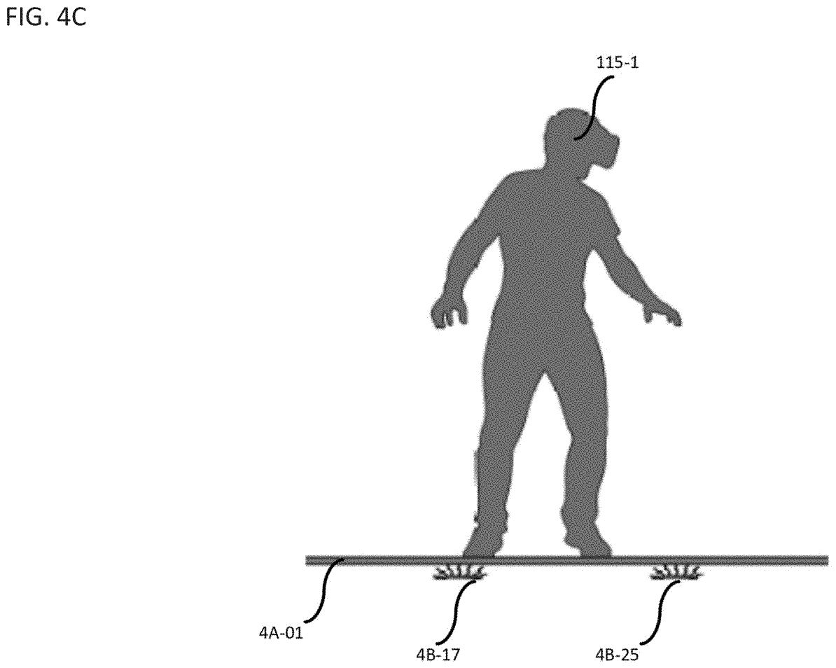

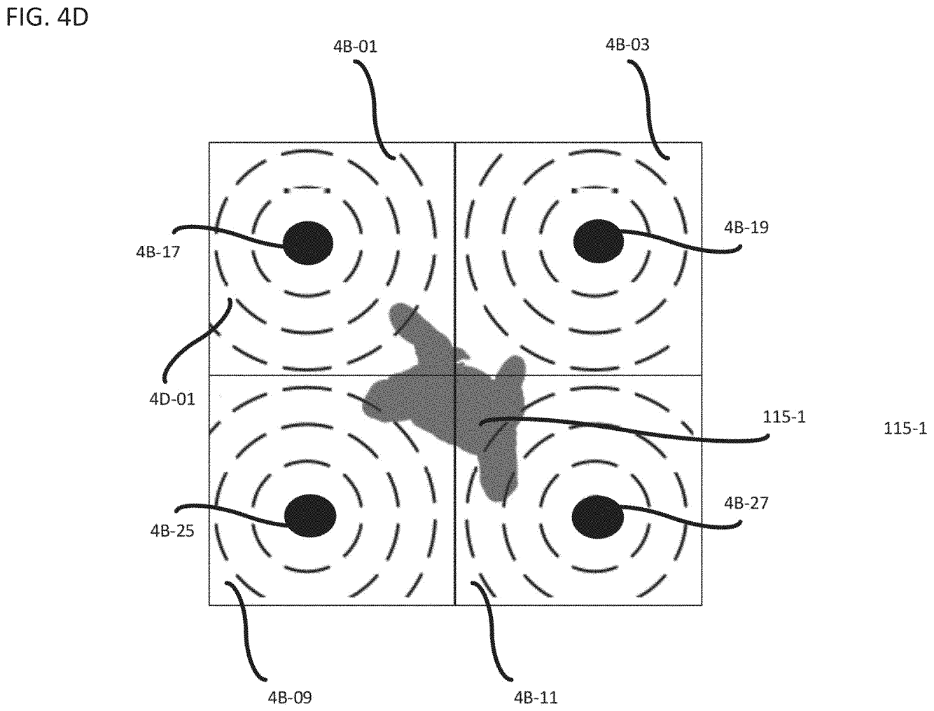

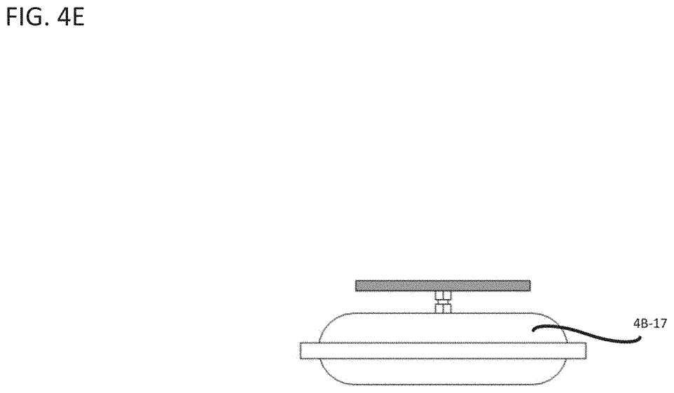

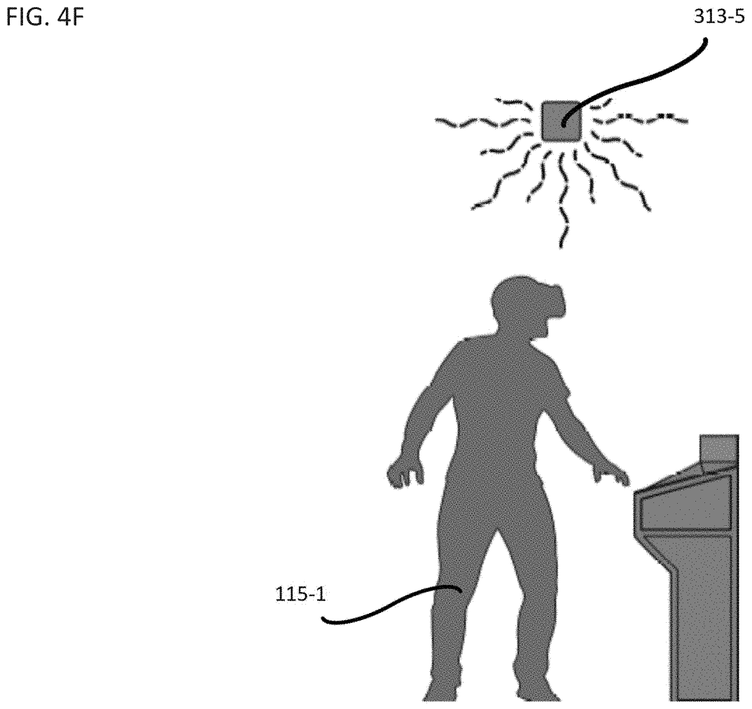

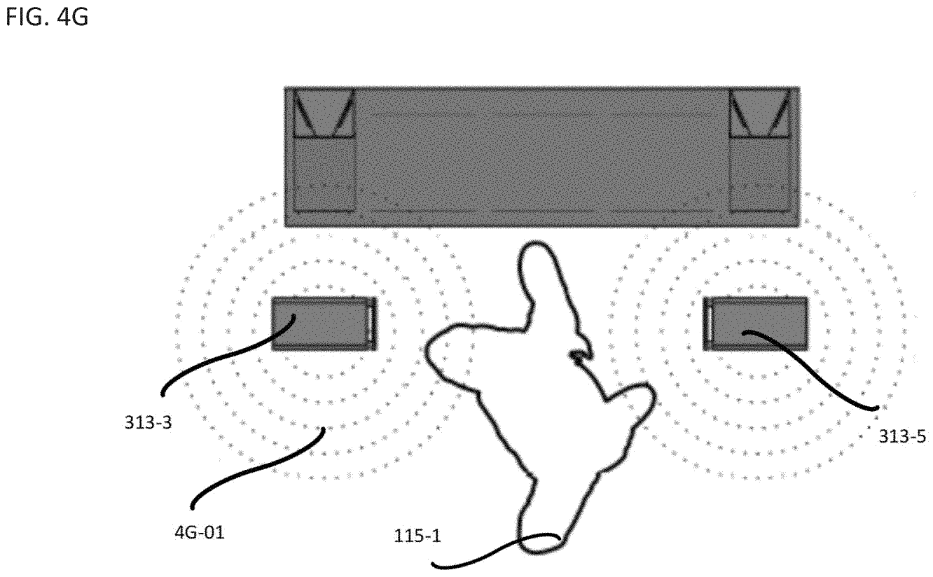

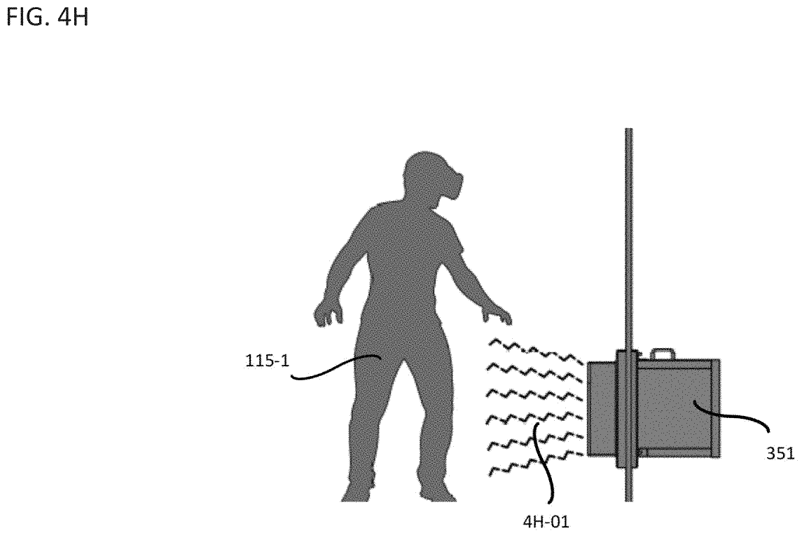

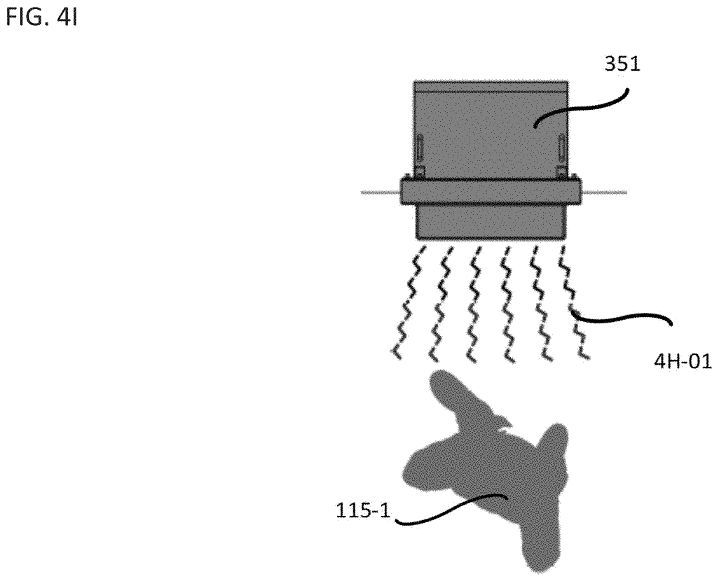

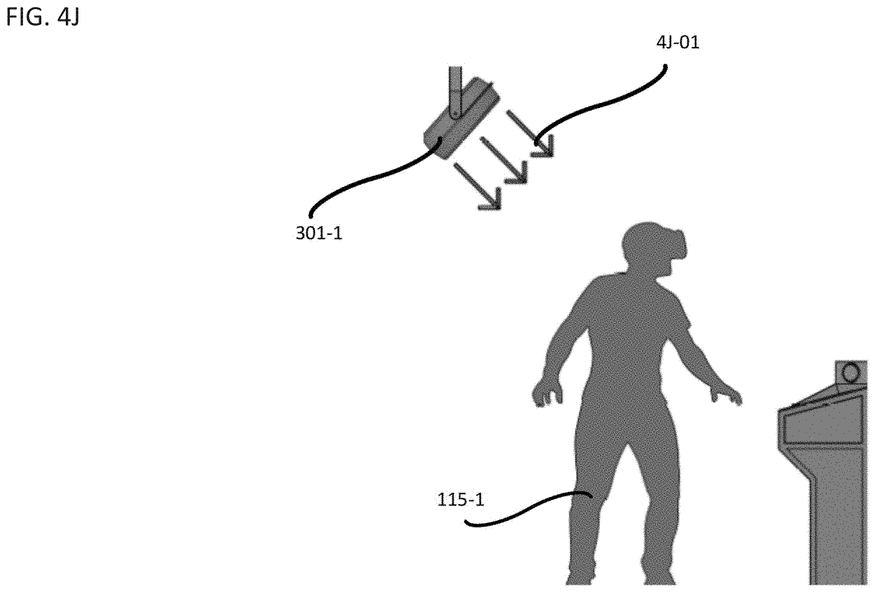

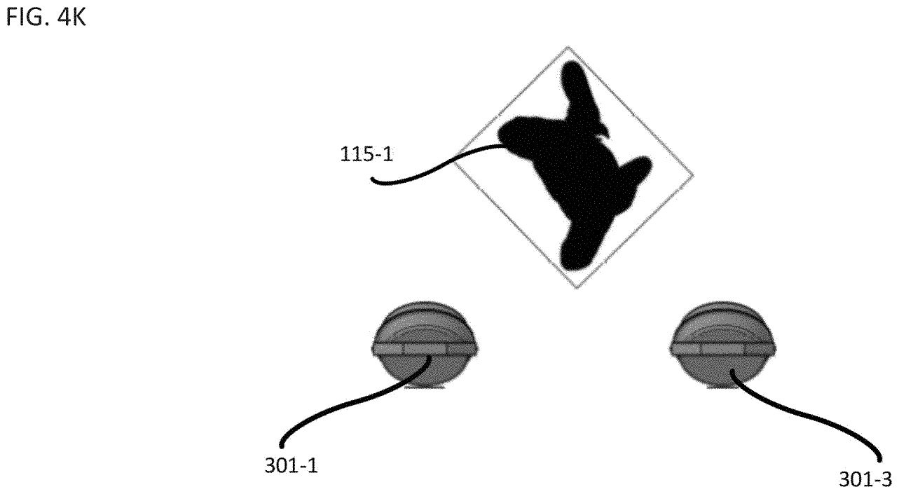

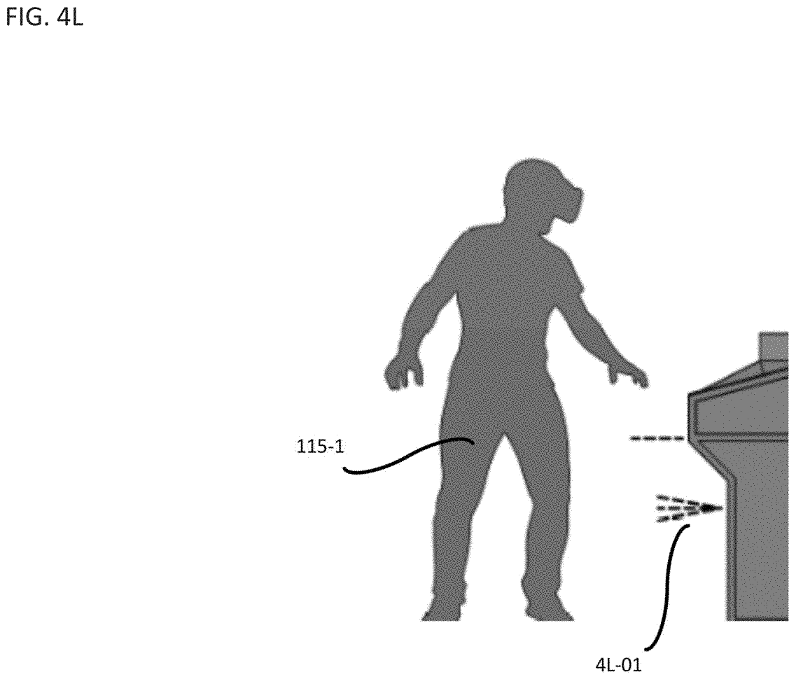

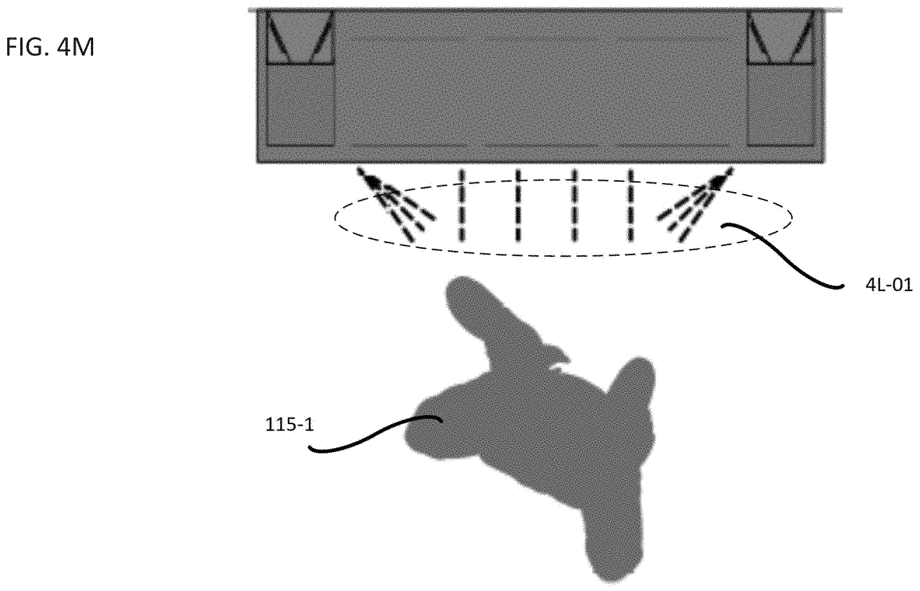

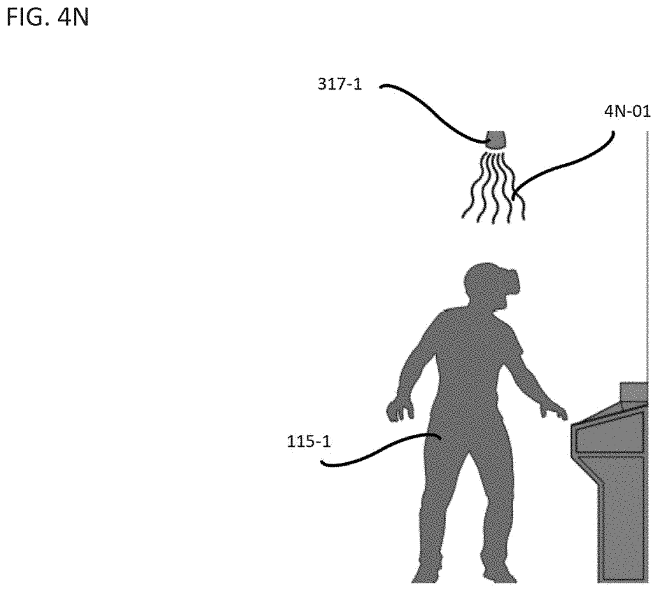

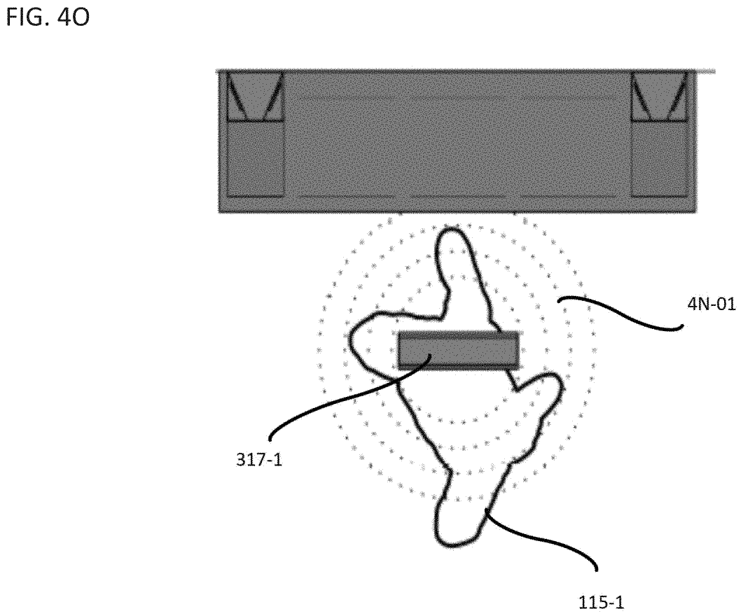

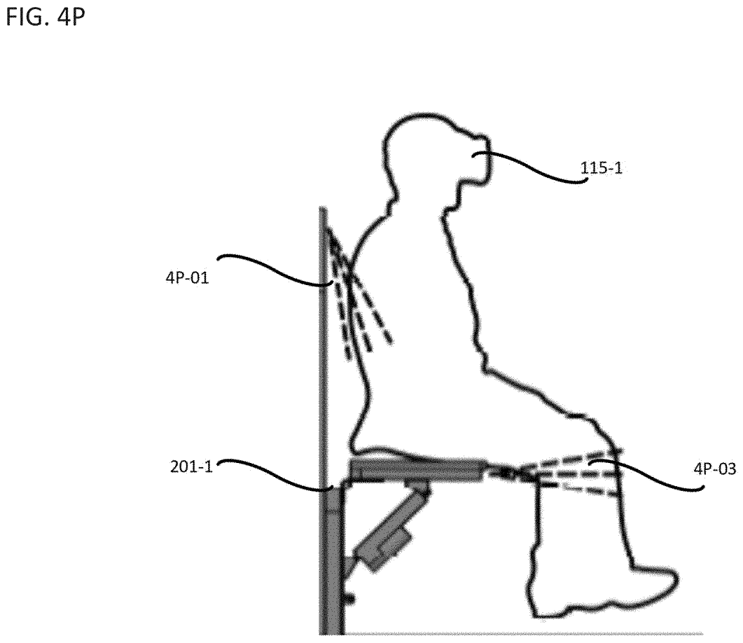

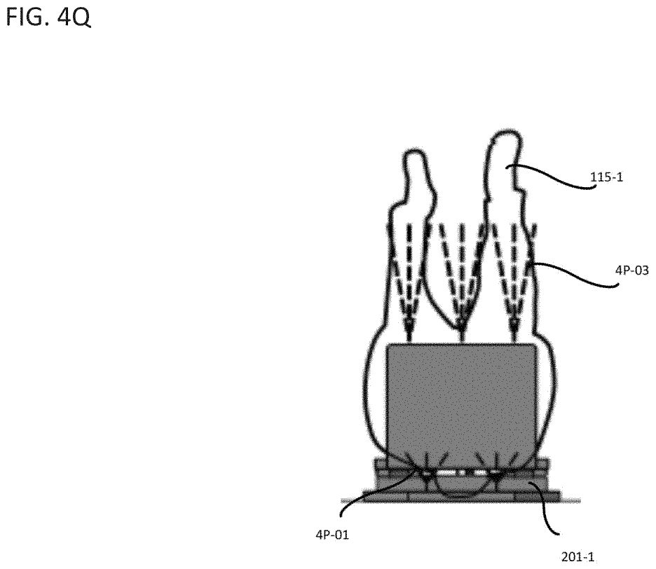

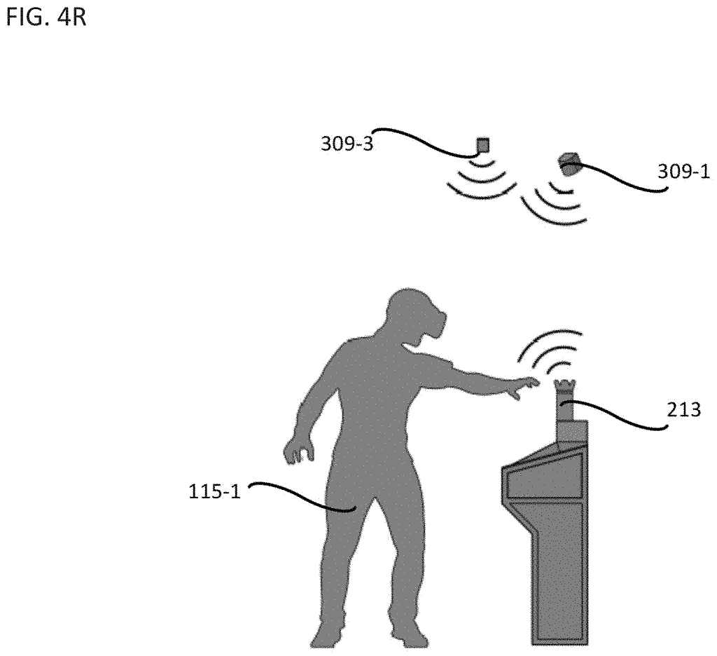

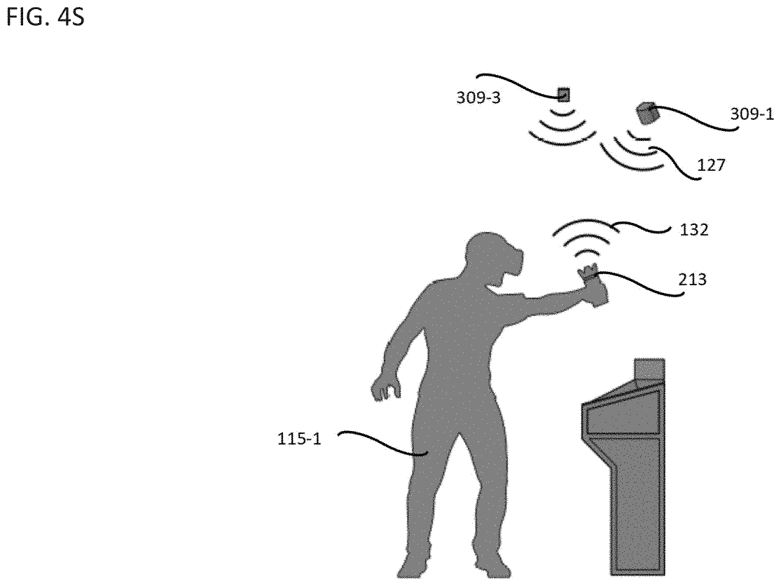

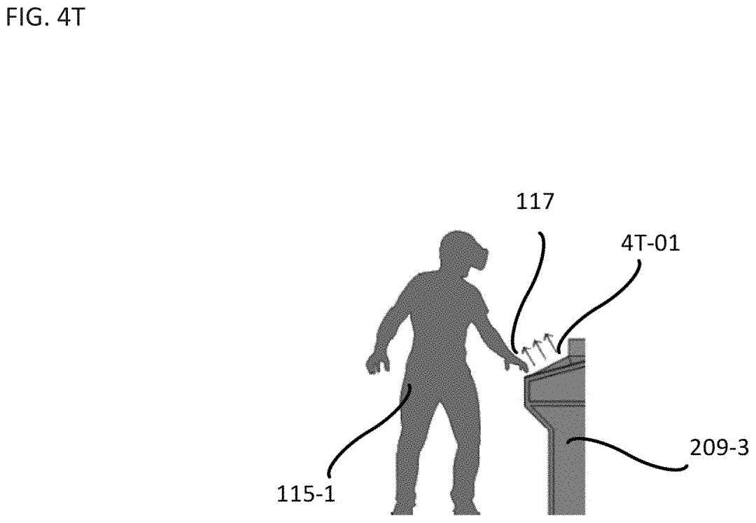

An example embodiment of one or more immersive effects subsystems 120 implemented within, for example, arena 111-1 of FIG. 1B is given in FIGS. 2A, 3A, 3B and 4A-4T. The one or more immersive effects subsystems 120 are distributed throughout the interior of the arena and are mounted on, for example, the ceiling or top interior perimeter of the arena, along the walls of the arena and on the floor of the arena. In some embodiments, the one or more immersive effects subsystems 120 comprises at least one of
a rumble or motion floor, as explained in detail below and with reference to FIGS. 4A, 4B, 4C, 4D, and 4E;
a heating and cooling effects subsystem comprising, for example, heating elements 313-1, 313-3 and 313-5; and 313-7 as shown in FIGS. 3A, 4F and 4G and an air-conditioning unit 351 as detailed in FIGS. 3B, 4H and 4I;
a wind effects subsystem, comprising, for example, fans 301-1, 301-3, 301-5 and 301-7 as shown in FIGS. 3A, 4J and 4K;
an air blast subsystem, as explained in further detail below and in FIGS. 4L and 4M;
an olfactory effects subsystem, comprising, for example, scent units 317-1 and 317-3 as explained in further detail below, and with reference to FIGS. 3A, 4N and 4O;
a pneumatic hand scan subsystem, as explained in further detail below;
a rotating pillar subsystem, comprising, for example, gunner pillar 207-5, engineering pillar 211-3, and ammunition recharge pillars 215-1 and 215-3 as shown in FIG. 2A;
a virtual reality folding seat effects subsystem comprising folding seats 201-1, 201-3 and 201-5 as shown in FIG. 2A and detailed further below and in FIGS. 4P and 4Q;
an object interaction subsystem, comprising, for example, ammunition canister 213 as shown in FIG. 2A and detailed further below and in FIGS. 4R and 4S; and
a haptic interaction subsystem, as explained in further detail below and with reference to FIG. 4T.

An example process for generating immersive effects is shown in FIG. 1C and described with reference to FIGS. 1A and 1C. In step 1C-01, inputs 117 are received by input subsystems 130 from one or more players 115. In step 1C-02, input signals 132 are generated by the input subsystems 130 based on the inputs received in step 1C-01 and transmitted to gaming control subsystem 125 for processing. These two steps have been explained in detail previously. In step 1C-03, gaming control subsystem executes one or more programs with data 126.

Then, in step 1C-04, based on at least one of:
the processing of one or more input signals 132 received by gaming control subsystem 125 in step 1C-02, and
the gaming control subsystem 125 executes at least one program using at least one portion of data in step 1C-03, wherein the at least one program and the at least one portion of data are part of the one or more programs and data 126 stored by gaming control subsystem 125,
   the gaming control subsystem 125 generates and transmits one or more immersive effects signals 127 to control the immersive effects subsystems 120.

In step 1C-05, the one or more immersive effects subsystems 120 receive the transmitted immersive effects signals 127, and produce one or more immersive effects 137 for the corresponding one or more players based on the received one or more immersive effects signals 127.

As explained above, in some example embodiments, at least some portion of gaming control subsystem 125 is located within control room 105. Then, the immersive effect signals 127 are transmitted from control room 105 via the communicative coupling between arena 111-1 and control room 105. The communicative coupling between arena 111-1 and control room 105 has been previously described.

The immersive effects subsystems are described in further detail below. An example of an immersive effects subsystem 120 is a rumble or motion floor located in one of the arenas 110. An example is shown in FIG. 4A, where rumble floor 4A-01 is located in arena 111-1. In some embodiments, the floor is divided into sections in the playing area in an arena. In some embodiments, these sections are evenly spaced. For example, in FIG. 4B, rumble floor 4A-01 is divided into sections 4B-01, 4B-03, 4B-05, 4B-07, 4B-09, 4B-11, 4B-13 and 4B-15. Each of these sections comprises a corresponding vibration motor or transducer. For example, in FIG. 4B:
section 4B-01 comprises transducer 4B-17;
section 4B-03 comprises transducer 4B-19;
section 4B-05 comprises transducer 4B-21;
section 4B-07 comprises transducer 4B-23;
section 4B-09 comprises transducer 4B-25;
section 4B-11 comprises transducer 4B-27;
section 4B-13 comprises transducer 4B-29; and
section 4B-15 comprises transducer 4B-31.

Then, referring to FIG. 1A, when the transducers in the rumble floor receive immersive effect signals 127 generated by, for example, a Unity game sending a UDP command to a PLC controller within gaming control subsystem 125, the transducers can vibrate at varying intensities and intervals to produce one or more immersive effects 137 for the one or more players 115.

In some embodiments, the immersive effects produced by the transducers reinforce the audio effects produced by the speakers. This is achieved by, for example, correlation of the immersive effects signals sent to the transducers, with the signals sent to the audio speakers. Then, as shown in FIG. 4C, when a player such as one or more players 115-1 walks on rumble floor 4A-01, transducers such as transducers 4B-17 and 4B-25 produce immersive effects 137 in the form of vibrations depending on the immersive effect signals 127 received by the transducers. FIG. 4D shows another example embodiment, where a player such as one or more players 115-1 is moving between sections 4B-01, 4B-03, 4B-09 and 4B-11. The transducers 4B-17, 4B-19, 4B-25 and 4B-27 corresponding to these sections respectively then produce vibrations based on the immersive effects signals received by these transducers. For example, transducer 4B-17 produces vibrations 4D-01. Transducer 4B-17 is shown in detail in FIG. 4E, for attachment to the bottom of the rumble floor. The operation of a transducer such as transducer 4B-17 to produce vibrations in response to receiving signals is well known to those of skill in the art.

Another example of an immersive effects subsystem 120 is a heating and cooling effects subsystem located in one of the arenas 110. In some embodiments, the heating and cooling effects subsystem comprise heating elements mounted into the top interior perimeter of a playing area in one of arenas 110. Then, when the heating elements receive immersive effect signals 127 generated by, for example, a Unity game sending a UDP command to a PLC controller within gaming control subsystem 125, the heating elements can generate heat at varying intensities and intervals to produce one or more immersive effects 137 for the one or more players 115. In some embodiments, these immersive effects 137 are integrated into the gameplay design to create feedback to instruct one or more players 115 on what they are doing correctly or incorrectly.

An example of the operation of the heating elements is illustrated with reference to FIGS. 3A, 4F and 4G. In FIG. 4F and 4G, one or more players 115-1 stands between heating elements 313-3 and 313-5. Heating elements 313-3 and 313-5 receive one or more immersive effect signals 127 and produce immersive effects 137 in the form of heat. For example, heating element 313-3 produces immersive effects 137 in the form of heat 4G-01 in response to receiving immersive effect signals 127. This creates feedback to instruct one or more players 115-1 to take the appropriate action.

Similarly, cooling elements in, for example, the form of air-conditioning can be used for the same purposes. An example is shown in FIGS. 3B, 4H, and 4I. As shown in FIG. 3B, air conditioning unit 351 is located proximate to navigation console 209-1 and navigation pillar 209-5. As shown in FIGS. 4H and 4I, air-conditioning unit 351 produces immersive effects 137 in the form of cold air 411-01 for one or more players 115-1 in response to receiving immersive effect signals 127.

Another example of an immersive effects subsystem 120 is a wind effects subsystem located in one of the arenas 110. In some embodiments, the wind effects subsystem comprise fans mounted into the top interior perimeter of the playing area in one of arenas 110. Then, when the fans receive immersive effect signals 127 generated by, for example, a Unity game sending a UDP command to a PLC controller within gaming control subsystem 125, the fans can generate air flow at varying intensities and intervals to produce one or more immersive effects 137 for the players 115.

A detailed embodiment of the operation of the fans 301-1 and 301-3 is shown with reference to FIGS. 3A, 4J and 4K. In FIG. 4J, based on immersive effect signals 127, fan 301-1 provides air flow 4J-01, so as to produce one or more immersive effects 137 for one or more players 115-1. As shown in FIG. 4K, player 115-1 can receive immersive effects 137 as a result of the air flows produced by fans 301-1 and 301-3.

Another example of an immersive effects subsystem 120 is an air blast subsystem located in one of the arenas 110. In some embodiments, the air blast subsystem comprise pneumatic tubing lined throughout the interior of the arena and connected to an air compressor in an arena such as arena 111-1 of FIG. 1B. Then, when the air compressor receives immersive effect signals 127 generated by, for example, a Unity game sending a UDP command to a PLC controller within gaming control subsystem 125, a blast of air can be created on demand to produce one or more immersive effects 137 for the one or more players 115. These immersive effects simulate, for example, decompression and lift off effects.

An example embodiment is shown in FIGS. 4L and 4M. Air blast 4L-01 is produced for one or more players 115-1, from pneumatic tubing lined throughout arena 111-1 and based on immersive effects signals 127 sent to an air compressor.

Another example of an immersive effects subsystem 120 is an olfactory effects subsystem located in one of the arenas 110. In some embodiments, the olfactory effects subsystem comprise scent units mounted into the top interior perimeter of the playing area in one of arenas 110. Then, when the scent units receive immersive effect signals 127 generated by, for example, a Unity game sending a UDP command to a PLC controller within gaming control subsystem 125, different scents can be created on demand to produce one or more immersive effects 137 for the one or more players 115.

An example embodiment of an olfactory effects subsystem is shown in FIGS. 4N and 4O. Scent 4N-01 is produced by scent unit 317-1 in arena 111-1 so as to produce one or more immersive effects 137 for one or more players 115-1. The scent 4N-01 is generated based on immersive effect signals 127 sent to the scent unit 4N-01.

In some embodiments, some of the immersive effects subsystems 120 are also input subsystems 130. These subsystems accept inputs 117 from one or more players 115 and generate input signals 132; as well as receive immersive effects signals 127 from gaming control subsystem 125 and produce immersive effects 137.

An example is a pneumatic hand scan subsystem. This produces air blasts based on biometric scanning of a player's hand. Specifically, the pneumatic hand scan subsystem comprises a pressurized air system expelling one or more blasts of air from one or more nozzles or perforation or more than one nozzle or perforation across the hand of a player.

In some embodiments, referring to FIG. 1A, when one of the one or more players 115 provides an input 117 by placing their hand such that it is detected by a biometric sensor embedded in a playing area of one of arenas 110, an input signal 132 is sent to gaming control subsystem 125. In some embodiments, the input signals 132 comprise UDP commands which are sent to a PLC controller and on to a Unity game which are part of gaming control subsystem 125. The Unity game performs processing to verify if the one of the one or more players 115 is scanning at the correct point during a game. If this is verified as correct, in some embodiments the Unity game then sends a UDP command to the PLC controller. The PLC controller then sends immersive signals 127 to an air compressor which is part of the pneumatic hand scan subsystem. The air compressor then produces immersive effects 137 in the form of air blasts to simulate a laser scanning the player's hand. The air blast is controlled through monitoring at least one of physical contact and visual determination of the player's hand location and programmatically activating an electrical solenoid valve.

Another example is a rotating pillar subsystem. In some embodiments, the rotating pillar subsystem comprises a rotating pillar in the playable area. One of the one or more players 115 provides an input 117 by rotating the pillar to reveal a separate interactive object within. The pillar enclosure is mounted and controlled by a motor that detects each incremental rotation and transmits an input signal 132 to a PLC controller, which is part of the gaming control subsystem 125. The PLC controller then sends it to the Unity game, which is also part of gaming control subsystem 125. The Unity game processes the input signal 132. Based on the processing, the Unity game produces immersive effects signals 127 to match the rotation in virtual reality to create immersive effects 137, and thereby produce an immersive experience for one or more players 115. This enables objects to be revealed at the right game moments and replaced for the next groups to reduce room resetting labor.

Another example is a virtual reality folding seat. To further enhance the playable space, a virtual reality folding seat may be provided in at least one of arenas 110. The virtual reality folding seat plays a role as part of input subsystems 130. When one of the one or more players 115 sits on the folding seat or stands up from a seated position on the folding seat, the seat transitions from one state to another, that is, from either folded to unfolded or from unfolded to folded. When this transition occurs, an input 117 is supplied to input subsystem 130; that is, the transition is detected. Based on this supplied input, input subsystem 130 generates and transmits one or more input signals 132.

The virtual reality folding seat is also part of the immersive effects subsystems 120 as it produces one or more immersive effects 137 to allow one of the one or more players 115 to undergo both seated and standing experiences to maximize the playable area. An example is shown with reference to FIGS. 3A, 4P and 4Q. In FIGS. 4P and 4Q, folding seat 201-1 shown in FIG. 3A produces one or more immersive effects 137 in the form of air blasts 4P-01 and 4P-03 for one of the one or more players 115-1.

Another example is an object or tactile interaction subsystem. In some embodiments, the object or tactile interaction subsystem comprises multiple mechanisms for physical interactions, such as levers, buttons, and switches which are installed within a playing area of one of arenas 110. When one of the one or more players 115 interacts with these mechanisms to produce an input 117 by, for example, pressing them, their activation sends input signals 117 to gaming control subsystem 125. In some embodiments, the input signals 117 comprise UDP commands which are sent to a PLC controller and on to a Unity game which are part of gaming control subsystem 125. Then, the gaming control subsystem 125 processes these input signals 132 and interacts with the object or tactile interaction subsystem to produce immersive effects 137 which match the in-game virtual reality visuals for the one or more players 115. This in effect creates a 1 to 1 experience where the player interactions are mirrored in the digital world to create an immersive experience.

An example embodiment is detailed in FIGS. 4R and 4S. As shown in FIG. 4R, ammunition canister 213 is part of input subsystems 130 and immersive effects subsystem 120, and is communicatively coupled to gaming control subsystem 125 via base stations 309-1 and 309-3. In FIG. 4S, when one of the one or more players 115-1 sends an input 117 to ammunition canister 213 by lifting ammunition canister 213, one or more input signals 132 are sent to gaming control subsystem 125. In response to receiving one or more input signals 132, gaming control subsystem 125 generates and transmits immersive effects signals 127 to ammunition canister 213, which generates immersive effects 137 for the one or more players 115-1.

Yet another example is a haptic interaction subsystem. In some embodiments, the haptic interaction comprises one or more devices or components which trigger human mechanoreceptors that enforce the sense of movement to the brains of the one or more players 115-1. This enables the one or more player's minds to correlate these events with other audiovisual effects 139 and immersive effects 137. In some embodiments, when a player supplies an input 117 by, for example, performing a touch interaction with input subsystems such as pillars 209-3, 207-5 and 211-3; then immersive effects in the form of blasts of air are supplied towards the players' hands by these subsystems.

An example is shown in FIG. 4T. One of the one or more players 115-1 supplies input 117 by interacting with pillar 209-3, which then sends an input signal 132 to gaming control subsystem 125. In response, gaming control subsystem 125 then generates and transmits immersive effects signals 127 to pillar 209-3, which supplies immersive effects in the form of blasts of air 4T-01 to the hands of one or more players 115-1.

Some of the other equipment such as fans 301-1 in FIG. 3A, the air nozzles which produce air blasts 4P-01 and 4P-03 in FIG. 4P; and the transducers such as transducers 4B-17 and 4B-25 which are part of the rumble floor 4B-01 in FIG. 4B; are also part of the haptics subsystem as they also perform the above-described human mechanoreceptor triggering.

Each of the arenas 110 also includes one or more audiovisual output subsystems 135 communicatively coupled to the gaming control subsystem 125. The one or more audiovisual output subsystems 135 comprise, for example:
virtual reality headphones, and virtual reality headsets, which are worn by the players and coupled to gaming control subsystem 125 by, for example, wireless headset receivers 311-1, 311-3 and 311-5. These headsets and headphones produce audiovisual effects for players based on signals generated by the gaming control subsystem 125;
ultrasonic speakers, such as ultrasonic speakers 307-1, 307-3 and 307-5 shown in FIG. 3A, and speakers 217-1, 217-3, 217-5 and 217-7 from FIG. 2A;
sub woofers, such as sub-woofers 303-1 and 303-3 shown in FIG. 3A;
sub speakers, such as sub-speakers 305-1, 305-3, 305-5, 305-7, 305-9 and 305-11 shown in FIG. 3A;
transducers, and
other appropriate audiovisual devices known to those of skill in the art.

The audiovisual output subsystems 135 may also comprise spatial audio within an arena, further providing one or more players 115 with a virtual reality experience.

An example process for generating audiovisual effects is shown in FIG. 1D. In step 1D-01, inputs 117 are received by input subsystems 130 from one or more players 115. In step 1D-02, input signals 132 are generated by the input subsystems 130 based on the inputs received in step 1D-01 and transmitted to gaming control subsystem 125 for processing. These two steps have been explained in detail previously. In step 1D-03, the gaming control subsystem executes one or more programs with data 126.

Then, in step 1D-04, based on at least one of:
the processing of one or more input signals 132 received by gaming control subsystem 125 in step 1D-02, and
the gaming control subsystem 125 executes at least one program using at least one portion of data in step 1D-03, wherein the at least one program and the at least one portion of data are part of the one or more programs and data 126 stored by gaming control subsystem 125,
   the gaming control subsystem 125 generates and transmits one or more immersive effects signals 127 to control the audiovisual output subsystems 120.

In step 1D-05, the one or more audiovisual output subsystems 135 receives the transmitted output signals 129, and produces one or more audiovisual effects 139 for the corresponding one or more players based on the received one or more output signals 129.

As explained above, in some example embodiments, at least some portion of gaming control subsystem 125 is located within control room 105. Then, the output signals 129 are transmitted from control room 105 via the communicative coupling between arena 111-1 and control room 105. The communicative coupling between arena 111-1 and control room 105 has been previously described.

Referring to FIG. 3A, in addition to the above, in some embodiments, an arena such as arena 111-1 comprises security subsystems such as security cameras 315-1 and 315-3. This enables the arena to be monitored from, for example, control room 105 or remotely. Examples of monitoring from control room 105 will be described further below.

Additionally, an arena such as arena 111-1 comprises lighting subsystems such as LEDs 323-1, 323-3, 323-5, and 323-7. These lighting subsystems enable the arena 111-1 to be illuminated.

Finally, an arena such as arena 111-1 comprises one or subsystems for external viewing. For example, arena 111-1 comprises web camera 321 to enable spectators external to the arenas and even the portal to view the players 115-1 within arena 111-1 in action within the arena.

As also explained previously, acoustics within portable or mobile spaces such as shipping containers may be challenging. In some embodiments, sound dampening panels are attached to the walls of the arenas 110 to enable better acoustics.

As also explained above and shown in FIGS. 2A and 3A, an arena such as arena 111-1 is extremely densely packed and populated with one or more players 115-1. Therefore, a lot of heat is produced within the arena, necessitating that the heating, ventilation and air conditioning (HVAC) subsystems employed within the arena is adequate. Air conditioning unit 351 shown in FIG. 3B then plays an important role in ensuring that the temperature within arena 111-1 is controlled, along with providing immersive effects. In some embodiments, at least some part of the HVAC subsystem is installed within a roll cage. For example, in some embodiments, air conditioning unit 351 is installed within a roll cage.

Finally, in order to ensure adequate electrical safety within an arena such as arena 111-1, a relay box such as relay box 319 in FIG. 3A is installed in arena 111-1.

While embodiments of the portal for multiplayer virtual reality games and method of its use have been illustrated in the accompanying drawings and described herein, it will be appreciated by those skilled in the art that various modifications, alternate constructions and equivalents may be employed.

What is claimed is:

1. A system for immersive effects in a portal implemented using a portable space for multiplayer virtual reality games, wherein:
the portal comprises a control room and a plurality of arenas,
wherein
the plurality of arenas are in proximity to the control room,
the plurality of arenas are communicatively coupled to the control room,
each of the plurality of arenas accommodates a corresponding one or more players,
each of the plurality of arenas comprises one or more immersive effects subsystems communicatively coupled to at least one gaming control subsystem,
the one or more immersive effects subsystems receiving one or more immersive effects signals from the at least one gaming control subsystem, and
the one or more immersive effects subsystems produces one or more immersive effects for the corresponding one or more players based on the received one or more immersive effects signals,
the at least one gaming control subsystem receiving one or more input signals from one or more communicatively coupled input subsystems,
the one or more input signals generated by the one or more input subsystems based on receiving one or more inputs related to a game,
the at least one gaming control subsystem generating the immersive effects signals based on at least one of:
the at least one gaming control subsystem executing one or more programs related to the game using data related to the game, and
the at least one gaming control subsystem processing the one or more input signals.

2. The system of claim 1, wherein
the one or more immersive effects subsystems comprise at least one of
a rumble or motion floor,
a heating and cooling effects subsystem,
an air blast subsystem,
a wind effects subsystem,
an olfactory effects subsystem,
an object or tactile interaction subsystem,
a pneumatic hand scan subsystem,
a rotating pillar subsystem,
a virtual reality folding seat effects subsystem, and
a haptic interaction subsystem.

3. The system of claim 1, wherein the one or more immersive effects comprise
blasts of air,
air flows of varying intensity and intervals,
scents,
heating and cooling effects, and
vibrating floor sections.

4. The system of claim 2, wherein the rumble or motion floor comprises a plurality of sections, and each of the plurality of sections comprises a transducer.

5. A method for immersive effects in a portal implemented using a portable space for multiplayer virtual reality games, wherein:
the portal comprises at least one control room communicatively coupled to a plurality of arenas,
each of the plurality of arenas accommodates a corresponding one or more players,
each of the plurality of arenas comprises:
one or more immersive effects subsystems communicatively coupled to at least one gaming control subsystem,
the method comprises:
receiving, by the one or more immersive effects subsystems, one or more immersive effects signals from the at least one gaming control subsystem, wherein
the one or more immersive effects signals are generated by the at least one gaming control subsystem based on at least one of
the at least one gaming control subsystem executing one or more programs and data related to the game, and
the at least one gaming control subsystem processing one or more input signals received from one or more input subsystems located within each of the plurality of arenas, and
producing, by the one or more immersive effects subsystems, one or more immersive effects for the corresponding one or more players based on the received one or more immersive effects signals.

6. The method of claim 5, wherein some of the one or more input subsystems are immersive effects subsystems

7. The method of claim 5, wherein the one or more input signals comprises a User Datagram Protocol (UDP) command.

8. The method of claim 5, wherein the gaming control subsystem comprises a Unity game.

9. The method of claim 5, wherein the gaming control subsystem comprises a programmable logic control (PLC) controller.

10. The method of claim 5, wherein said portable space comprises a shipping container adapted to include the control room, the arenas, the immersive effects subsystems.

11. The method of claim 10, wherein said shipping container includes external communication means.

12. The method of claim 5, wherein input subsystems comprise at least one console having physical features.

13. The method of claim 12, wherein said at least one console comprises a gunner console, a navigation console, an engineering console, an ammunition canister assembly, and combinations thereof.

14. The method of claim 5, wherein processing of input signals and the generation of various signals by the gaming control subsystem takes into account nature of the portable space.

15. The method of claim 5, wherein communications between each arena and control room is accomplished by a network connection.

16. The method of claim 15, wherein the network connection comprises a wired network.

17. The method of claim 15, wherein the network connection comprises a wireless network.

18. The method of claim 15, wherein said immersive effect signals communicate with immersive effects subsystems.

19. The method of claim 15, wherein said immersive effect subsystems comprise one or more of a rumble or motion floor, a heating and cooling effects subsystem, a wind effects subsystem, an air blast subsystem, an olfactory effects subsystem, a pneumatic hand scan subsystem, a rotating pillar subsystem, a virtual reality folding seat effects subsystem, an object interaction subsystem, a haptic interaction subsystem.

20. The method of claim 18, wherein said immersive effects subsystems communicate with arena floor sections independently to create different immersive effects for each section of the arena floor.
